(19) United States
(12) Patent Application Publication
(10) Pub. No.: US 2021/0329446 A1
(43) Pub. Date: Oct. 21, 2021

(54) SYSTEM AND METHOD OF DYNAMIC ASSIGNMENT OF IDENTIFIERS TO WIRELESS DEVICES

(71) Applicant: Verizon Patent and Licensing Inc., Basking Ridge, NJ (US)

(72) Inventors: Brian Olson, Clayton, CA (US); Matthew Nelson, Pleasanton, CA (US); Miguel A. Carames, Long Valley, NJ (US)

(21) Appl. No.: 16/854,166

(22) Filed: Apr. 21, 2020

(51) Int. Cl. H04W 8/26; H04W 8/12; H04W 12/06; H04W 12/00

(52) U.S. Cl. CPC H04W 8/26; H04W 12/00514; H04W 12/06; H04W 8/12

(57) ABSTRACT

A Device Roaming State Server (DRSS) may: receive a request, from a mobile device attached to a first network, to provide the mobile device with a Mobile Station International Subscriber Directory Number (MSISDN). The mobile device has an external identifier (ID) but does not have an MSISDN. The DRSS is in a second network. The DRSS may then authenticate the mobile device at the second network. If the mobile device is successfully authenticated, the DRSS may select a temporary MSISDN from a pool of available MSISDNs; associate the temporary MSISDN with the external ID in a database; and provide the mobile device with the MSISDN.

### BACKGROUND

In order to satisfy the needs and demands of users of mobile communication devices, providers of wireless communication services continue to improve available services. One aspect of such improvements includes the ability to provide wireless communication services to a wide range of mobile devices. One enhancement made possible through new broadband cellular networks is the ability to service Internet-of-Things (IoT). Such devices consume little power, and are typically not used for voice communications. Although each IoT device that is attached to a network must have a network identifier, if the IoT is not designed for voice communication, the IoT has no need to have a telephone number associated with the device.

### BRIEF DESCRIPTION OF THE DRAWINGS

FIG. 1 illustrates an exemplary network environment in which the concepts described herein may be implemented; \

FIG. 2 illustrates exemplary components that are included in the networks shown in FIG. 1;

FIG. 3 illustrates exemplary components of network devices included in the networks of FIGS. 1 and 2;

FIGS. 4A and 4B illustrate exemplary network components that may be included in the core network of FIG. 2 according to different implementations;

FIG. 5 illustrates exemplary fields of records of a table in a database of the Device Roaming State Server (DRSS) of FIGS. 4A and 4B;

FIG. 6A is a flow diagram of an exemplary process that is associated with allocating a Mobile Station International Subscriber Directory Number (MSISDN) to a User Equipment (UE) device according to one implementation;

FIG. 6B is a flow diagram of an exemplary process that is associated with releasing the MSISDN that has been assigned to the UE device during the process of FIG. 6B, according to one implementation; and

FIGS. 7A and 7B are signal flow diagrams that are associated with the processes of FIGS. 6A and 6B.

### DETAILED DESCRIPTION OF PREFERRED EMBODIMENTS

The following detailed description refers to the accompanying drawings. The same reference numbers in different drawings may identify the same or similar elements.

In implementations described herein, some mobile devices (e.g., some user equipment (UE) devices) may not each have a Mobile Station International Subscriber Directory Number (MSISDN) (e.g., a telephone number). For example, some devices not used for person-to-person voice communication may not need a telephone number (e.g., a motion sensor), but just a network identifier for digital, wireless communication. If such a device is at a foreign network, the foreign network may be unable to handle or provide communication services to the device. To allow such a device to freely roam into the foreign network and to let the foreign network provide communication services to the device, the home network may provision a temporary MSISDN to the device.

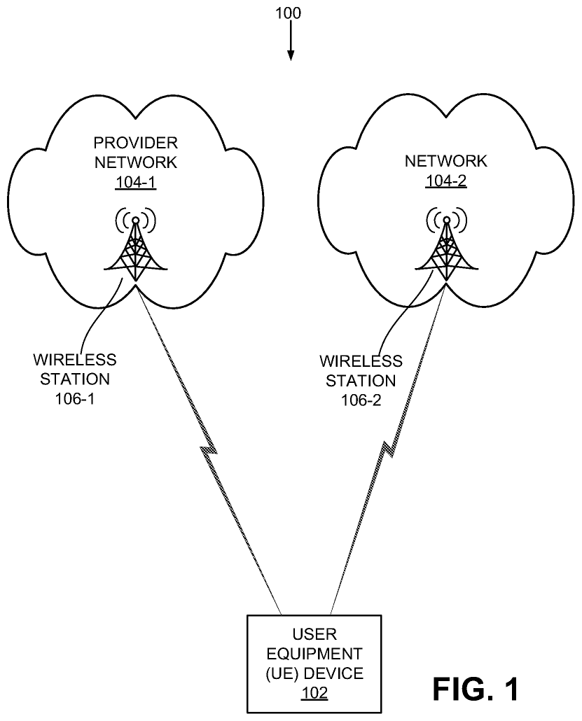

FIG. 1 illustrates the concept described herein. As shown, a UE device 102 is about to roam from a provider network 104-1 to network 104-2 (also referred to as foreign network or visiting network 104-2). Assume that UE device 102 has what is known as an External Identifier (ID) and that UE device 102 does not have an MSISDN (which may be typical of IoT type device). Also, assume that provider network 104-1 is the home network of UE device 102 and is capable of handling mobile devices that have External IDs but no MSISDNs. Further, assume that a partnership network 104-2 is a network to be visited or roamed into by UE device 102 and that network 104-2 is not capable of handling mobile devices without MSISDNs.

In FIG. 1, to allow UE device 102 to attach to network 104-2 and to be serviced by network 104-2, provider network 104-1 leases an MSISDN, from its pool of MSISDNs, to UE device 102 when UE device 102 either attaches to provider network 104-1 or requests provider network 104-1 to assign an MSISDN to UE device 102. The MSISDN lease is for a limited duration (e.g., a day, a week, a month, etc.). Once an MSISDN has been assigned, UE device 102 roams to visiting network 104-2 and receives various communication services. When UE device 102 returns to provider network 104-1, UE device 102 may release the MSISDN, allowing provider network 104-1 to return the MSISDN to its pool of MSISDNs that may be leased. Provider network 104-1 is then free to re-allocate the MSISDN to other devices. More detailed description of these concepts, the components in FIG. 1 and other network components for implementing the concepts follow.

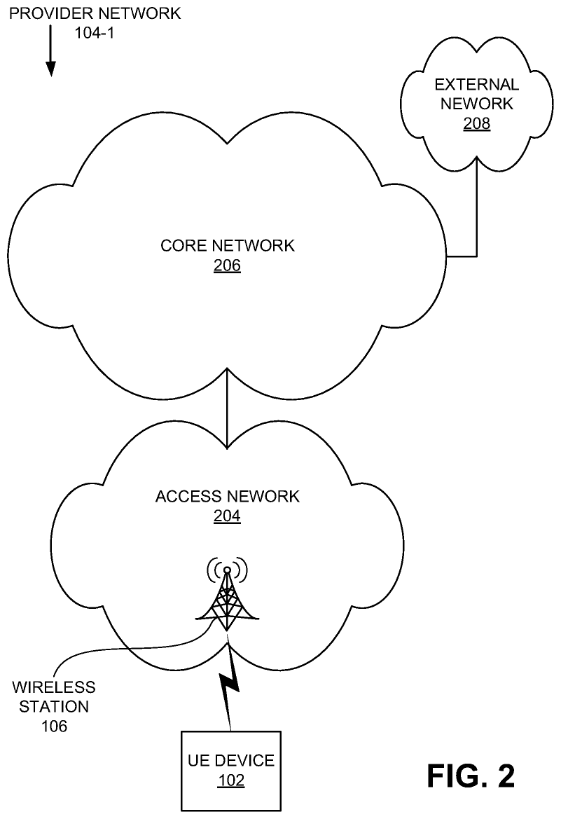

FIG. 2 illustrates exemplary components that are included in provider network 104-1. As shown, UE devices 102 (referred to individually as UE device 102) are attached to provider network 104-1, which includes an access network 204, a core network 206 and an external network 208. For simplicity, FIG. 2 does not show all components that may be attached to or included in provider network 104-1 (e.g., routers, bridges, wireless access point, additional networks, additional UE devices, etc.). That is, depending on the implementation, provider network 104-1 may include additional, fewer, different, or a different arrangement of components than those illustrated in FIG. 2.

UE device 102 may include a wireless communication device that includes a Subscriber Identity module (SIM) whose contents may be updated over-the-air (OTA). Examples of a UE device 102 that has or adapted to have a SIM card include: a smart phone; a tablet device; a wearable computer device (e.g., a smart watch); a global positioning system (GPS) device; a laptop computer; a media playing device; a portable gaming system; and an Internet-of-Thing (IoT) device. In some implementations, UE device 102 may correspond to a wireless Machine-Type-Communication (MTC) device that communicates with other devices over a machine-to-machine (M2M) interface, such as Long-Term-Evolution for Machines (LTE-M) or Category M1 (CAT-M1) devices and Narrow Band (NB)-IoT devices. UE device 102 may send packets over or to other devices in or over provider network 104-1.

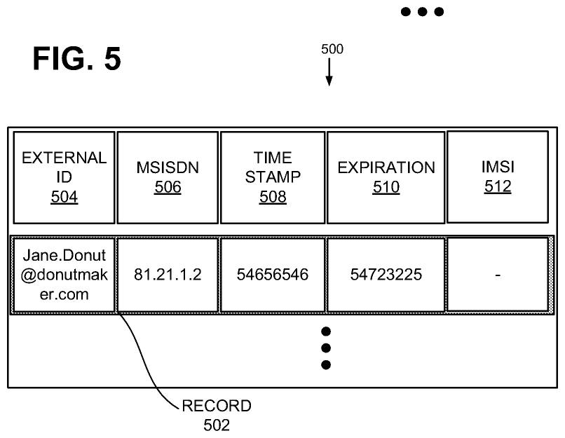

In the implementation shown, the SIM card (also referred to herein as embedded SIM, embedded Universal Integrated Circuit Card (eUICC), or simply SIM) in UE device 102 includes one or more External Identifiers (IDs) but not an MSISDN. The External ID identifies a subscription associated with an International Mobile Subscription Identifier (IMSI) stored in the SIM. An External ID and MSISDN are described in greater detail with reference to FIG. 5.

Because many provider networks cannot handle or service UE devices that do not have an MSISDN, for UE device 102 to freely roam in visiting networks, UE device 102 needs to acquire an MSISDN from provider network 104-1. Accordingly, when UE device 102 wants to roam, UE device 102 establishes a connection to its home provider network 104-1 that is capable of handling MSISDN-less devices. At this point, UE device 102 requests a MSISDN-leasing service from provider network 104-1. More specifically, an MSISDN renting program on UE device 102 transmits the External ID of UE device 102 to network 104-1 and obtains a temporary MSISDN. Once a MSISDN has been assigned and written into its SIM, UE device 102 is then free to roam to another network that may be incapable of handling MSISDN-less devices. When UE device 102 returns to its home network 104-1, UE device 102 may release the temporary MSISDN, allowing provider network 104-1 to recycle the MSISDN.

Access network 204 may allow UE device 102 to connect to core network 206. To do so, access network 204 may establish and maintain, with participation from UE device 102, an over-the-air channel with UE device 102; and maintain backhaul channels with core network 206. Access network 204 may convey information through these channels, from UE device 102 to core network 206 and vice versa.

Access network 104 may include a Long-term Evolution (LTE) radio network and/or a Fifth Generation (5G) radio network or other advanced radio network. These radio networks may include many wireless stations, one of which is illustrated in FIG. 2 as wireless stations 106 for establishing and maintaining an over-the-air channel with UE device 102.

Core network 206 may include a local area network (LAN), a wide area network (WAN), a metropolitan area network (MAN), an optical network, a cable television network, a satellite network, a wireless network (e.g., a CDMA network, a general packet radio service (GPRS) network, an LTE network (e.g., a 4G network), a 5G network, an ad hoc network, a telephone network (e.g., the Public Switched Telephone Network (PSTN), an intranet, or a combination of networks. Core network 206 may allow the delivery of Internet Protocol (IP) services to UE device 102, and may interface with other networks, such as external network 208.

Depending on the implementation, core network 206 may include 4G core network components (e.g., a Serving Gateway (SGW), a Packet data network Gateway (PGW), a Mobility Management Entity (MME), etc.), 5G core network components (e.g., a User Plane Function (UPF), an Application Function (AF), an Access and Mobility Function (AMF), a Session Management Function (SMF), a Unified Data Management (UDM) function, a Network Slice Selection Function (NSSF), a Policy Control Function (PCF), etc.), or another type of core network components.

In addition to some of the above-mentioned functional components, core network 206 may also include a Device Roaming State Server (DRSS) and a SIM-OTA. One of the reasons for implementing the DRSS is to allow a UE device 102 (serviced by provider network 104-1) that has an External ID but not an MSISDN to roam into a foreign network 104-2 that cannot handle MSISDN-less devices. The SIM-OTA provides over-the-air updates to SIM cards in UE devices 102.

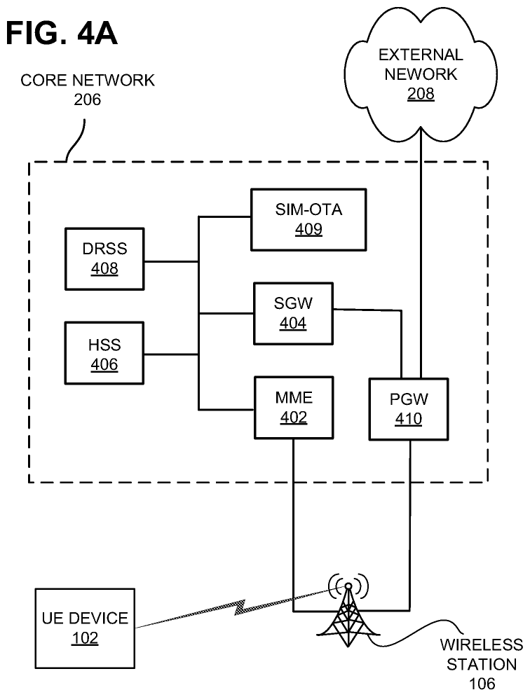

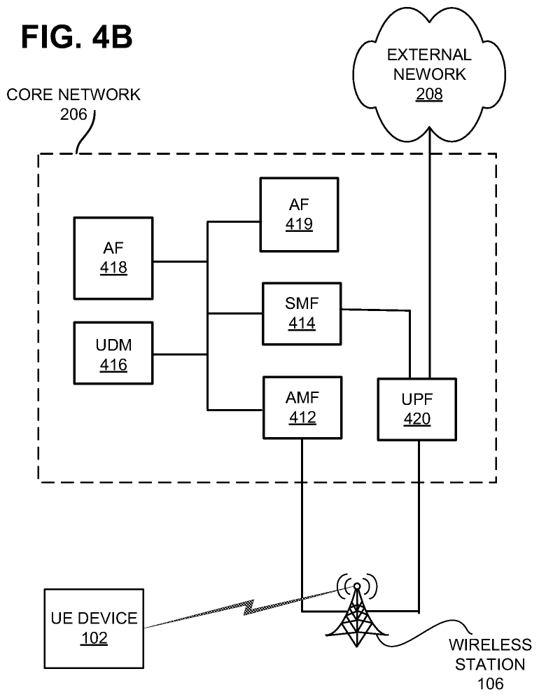

In an exemplary embodiment, the DRSS allocates a temporary MSISDN from its pool of MSISDNs in exchange for an External ID, for the UE device 102. The DRSS then instructs the SIM-OTA to update the UE device 102's SIM with the temporary MSISDN. The DRSS is described below in greater detail with reference to FIGS. 4A-7.

External network 208 may include networks that are external to core network 206. In some implementations, external network 208 may include packet data networks, such as an Internet Protocol (IP) network. An IP network may include, for example, an IP Multimedia Subsystem (IMS) network that may provide a Short Messaging Service (SMS), Voice-over-IP (VoIP) service, etc. In some implementations, external network 208, rather than core network 206, include a DRSS and/or a SIM-OTA.

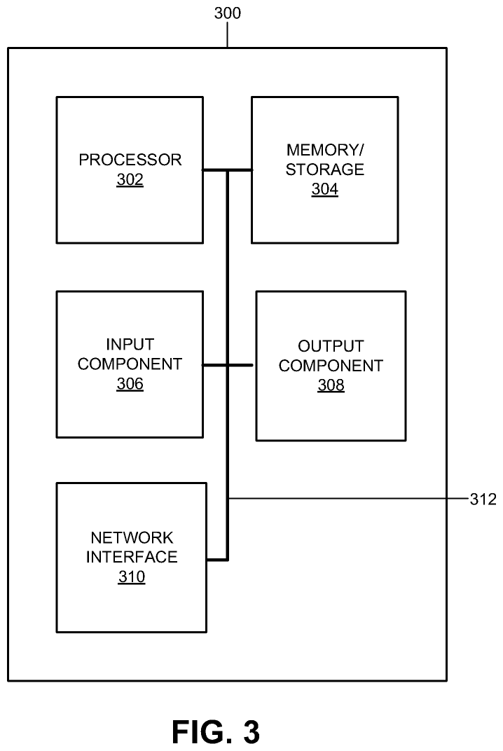

FIG. 3 is a block diagram of exemplary components of a network device 300. Network device 300 may correspond to, or be included in, the devices and/or components of the networks depicted in FIGS. 1 and 2 (e.g., UE device 102, wireless station 106, a router, a switch, a server, access network 204, core network 206, etc.). As shown, network device 300 may include a processor 302, memory/storage 304, input component 306, output component 308, network interface 310, and communication path 312. In different implementations, network device 300 may include additional, fewer, different, or a different arrangement of components than the ones illustrated in FIG. 3.

Processor 302 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling device 200 and/or executing programs/instructions.

Memory/storage 304 may include static memory, such as read only memory (ROM), and/or dynamic memory, such as random access memory (RAM), or onboard cache, for storing data and machine-readable instructions (e.g., programs, scripts, etc.).

Memory/storage 304 may also include a floppy disk, CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 304 may be external to and/or removable from network device 200. Memory/storage 304 may include, for example, a Universal Serial Bus (USB) memory stick, a dongle, a hard disk, off-line storage, a Blu-Ray® disk (BD), etc. Memory/storage 304 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 306 and output component 308 may receive input from a user and provide output to a user. Input/output components 306 and 308 may include, for example, a display screen, a keyboard, a mouse, a speaker, a microphone, a camera, a DVD reader, USB lines, and/or other types of components.

Network interface 310 may include a transceiver (e.g., a transmitter and a receiver) for network device 300 to communicate with other devices and/or systems. For example, via network interface 310, network device 300 may communicate over a network, such as the Internet, an intranet, a terrestrial wireless network (e.g., a WLAN, WiFi, WiMax, etc.), a satellite-based network, optical network, etc. Network interface 310 may include a modem, an Ethernet interface to a LAN, and/or an interface/connection for connecting device 300 to other devices (e.g., a Bluetooth interface).

Communication path 312 may provide an interface (e.g., a bus) through which components of device 300 can communicate with one another.

In some implementations, network device 300 may perform the operations described herein in response to processor 302 executing software instructions stored in a non-transient computer-readable medium, such as memory/storage 304. The software instructions may be read into memory/storage 304 from another computer-readable medium or from another device via network interface 310. The software instructions stored in memory/storage 304, when executed by processor 302, may cause processor 302 to perform processes that are described herein. In other implementations, the instructions may be hard coded. For example, when network device 300 is implemented as a DRSS device, the DRSS device may execute software instructions to lease temporary MSISDNs to UE devices 102 in exchange for their External IDs. In another example, when network device 300 is implemented as a UE device 102, UE device 102 may run software instructions to request a temporary MSISDN from provider network 104-1.

FIGS. 4A and 4B illustrate exemplary network components that may be included in the core network of FIG. 2 according to different implementations. More specifically, FIGS. 4A and 4B show core network components when core network 206 is implemented, respectively, as a 4G network and a 5G network. As shown in FIG. 4A, when implemented as part of a 4G network, core network 206 may include a Mobility Management Entity (MME) 402, a Serving Gateway (SGW) 404, a Home Subscriber Server (HSS) 406, a Device Roaming State Server (DRSS) 408, a SIM-OTA 409 (also called OTA 409) and a Packet Data Network Gateway (PGW) 410. Although core network 206 may include other 4G components, for simplicity, they are not illustrated in FIG. 4A.

MME 402 may provide control plane processing for core network 206. For example, MME 402 may implement tracking and paging procedures for UE device 102, may activate and deactivate bearers for UE device 102, may authenticate a user of UE device 102, and may interface to non-LTE radio access networks. A bearer may represent a logical channel with particular quality of service (QoS) requirements. MME 402 may also select a particular SGW 404 for a UE device 102. An MME 402 may interface with other MMES 402 in core network 206 and may send and receive information associated with UE devices 102, which may allow one MME 402 to take over control plane processing of UE devices 102 serviced by another MME 402, if the other MME 402 becomes unavailable. During the authentication of UE device 102 at MME 402, MME 402 may route messages to HSS 406 during authentication for verifying or validating UE device 102's identity.

MME 402 may communicate with other core network components to create and manage a new session for a UE device 102, for example, when the UE device 102 attaches to core network 206, when bearers need to be added or modified for an existing session for the UE device 102, when a connection to a new PGW 410 needs to be created, or during a handover procedure (e.g., when the UE device 102 needs to switch to a different SGW 404).

SGW 404 may provide an access point to UE device 102, handle forwarding of data packets for UE device 102, perform transport level markings (e.g., QCI), and act as a local anchor point during handover procedures between wireless stations (e.g., eNB). In addition, SGW 404 may forward messages between MME 402 and PGW 410. For example, when SGW 404 receives a message from MME 402 indicating that UE device 102 is unavailable to accommodate a request to change its bearer, SGW 404 may forward the message to PGW 410.

HSS 406 may provide user subscription, registration, and profile information to other components in network 104-1, and store such information, locally or at other network components (e.g., AAA). In one implementation, HSS 406 may store and/or access authentication information at the AAA. When MME 402 routs requests for authentication to HSS 406 from another network component, HSS 406 may access the AAA to retrieve user credentials and provide them to MME 402. In one implementation, HSS 406 may perform authentication on and/or other functions upon receipt of requests from DRSS 408.

HSS 406 may also receive requests from DRSS 408 to update subscription information associated a particular IMSI and UE device 102. The update may include writing a temporary MSISDN assigned to the UE device 102 and its External ID to the user profile or account. Once the update is complete, HSS 406 may receive requests from other network components regarding the UE device 102 and the MSISDN.

DRSS 408 may receive a requests for authentication and/or to lease a temporary MSISDN, from UE device 102. The request may provide an External ID associated with the UE device 102 that needs the MSISDN, a time interval for which the UE device 102 needs the MSISDN (or the time when the MSISDN lease should expire), and an IMSI. In some instances, when the request does not indicate for how long the MSISDN is to be leased, DRSS 408 may itself supply a default value.

When DRSS 408 receives an MSISDN request that includes an External ID associated with the UE device 102, DRSS 408 may request HSS 406 to authenticate UE device 102. If the authentication results in successful validation of UE device 102, DRSS 408 selects an MSISDN from its list of MSISDNs and removes the selected MSISDN from the list. In addition, DRSS 408 records, in its database, the External ID of the UE device 102 to which the MSISDN is leased and the IMSI of the UE device 102. If possible, DRSS 408 may also indicate how long the MSISDN is to be leased. The time information may be used, for example, to terminate the lease when the lease expires.

Upon selecting the temporary MSISDN for UE device 102, DRSS 408 may request HSS 406 to update the account or a profile associated with the UE device 102, with the temporary MSISDN and the External ID. When the update is complete, DRSS 408 instructs SIM-OTA 409 to send the selected MSISDN to the SIM of the UE device 102 and cause SIM to store the MSISDN.

DRSS 408 may also receive a request from UE device 102 that it has finished roaming and that it wants to return the leased MSISDN to DRSS 408. When DRSS 408 receives the notification, DRSS 408 may perform another authentication of UE device 102 at HSS 406. If the authentication validates the identity of the UE device 102, DRSS 408 requests SIM-OTA 409 to remove the MSISDN from the SIM in UE device 102. In addition, DRSS 408 may schedule the MSISDN to be returned to its pool of MSISDNs and request HSS 406 to perform any updates or cleanup activities on any records associated with the UE device 102 (e.g., remove the MSISDN from the records associated with the UE device).

When DRSS 408 terminates the lease of the MSISDN, depending on the implementation, DRSS 408 may use different procedures to recycle the MSISDN. For example, rather than immediately returning the MSISDN to its pool of free MSISDNs, in one implementation, DRSS 408 may maintain the status of the MSISDN as unavailable to be leased to other UE devices 102. In this scheme, DRSS 408 may continue to lease other MSISDNs from its pool until the pool is almost exhausted—only then does DRSS 408 attempt to return the MSISDN to the pool. Consequently, DRSS 408, HSS 406, and other network components also retain records accrued to the MSISDN, and provider network 104-1 can implements network policies that allow UE device 102 to continue to roam for an extended time after the expiry of temporary MSISDN.

In a different implementation, DRSS 408 may keep a table of MSISDNs that have been leased in the past. That is, for each of the MSISDNs, DRSS 408 may retain information about its past leases. Such information may include, for example, when a particular MSISDN was leased, to what UE devices 102 the MSISDN was leased, what networks UE devices 102 visited, and for how long the MSISDN was leased for each of the UE devices 102. Such information may later be used to determine UE device 102's roaming pattern. In addition, such information may be used to select a particular MSISDN for a UE device 102 (e.g., to support optimized MSISDN leases).

In the above MSISDN recycling schemes, DRSS 408 and other network components may delay the deletion of records associated with the expired MSISDN. Accordingly, other network components, such as HSS 406, may also delay the removal of information associated with the leased MSISDN. The delay between the MSISDN expiry and the removal of the records may provide the provider network 104-1 and visiting network 104-2 with a sufficient time to settle transactions. For example, if an MSISDN lease terminates while UE device 102 is still roaming, provider network 104-1 and visiting network 104-2 may use such delays to settle charges. If provider network 104-1 immediately deleted all records associated with the leased MSISDN upon its expiry, provider network 104-1 may be unable to properly charge UE device 102 for the service fees accrued at network 104-2, if the charges incurred at visiting network 104-2 are forwarded to provider network 104-1 long after the MSISDN expiry.

Referring to FIG. 4A, SIM-OTA 409 may provide updates to SIMs in UE devices 102. In particular, SIM-OTA 409 may receive instructions from DRSS 408 to update the SIM at UE device 102 with the MSISDN, either to store the temporary MSISDN in the SIM or to delete the MSISDN from the SIM. Since SIM-OTA 408 performs its updates as a service, information for updating the SIM is sent to UE device 102 over the user plane.

PGW 410 may function as a gateway to external network 208. In addition, when UE device 102 attaches to provider network 104-1, PGW 410 may allocate an IP address for UE device 102. Additionally, when PGW 410 receives a message from a Policy and Charge Rules Function (PCRF) to modify Quality-of-Service (QoS) for UE device 102, PGW 410 may dispatch a message to MME 402 (via SGW 404) to change the bearer for UE device 102.

FIG. 4B illustrates exemplary components of core network 206 when the core network 206 is implemented as a 5G core network. As shown, core network 206 may include: an Access and Mobility Function (AMF) 412, a Session Management Function (SMF) 414, a Unified Data Management (UDM) function 416, and a User Plane Function (UPF) 420. These components perform functions that are roughly equivalent to those of MME 402, SGW 404, HSS 406, and PGW 410, respectively. In addition, AFs 418 and 419 may be implemented to perform the functions of DRSS 408 and SIM-OTA 409. In the following, AFs 418 and 419 that perform the functions of DRSS 408 and SIM-OTA 409 are also referred to as DRSS 408 and SIM-OTA 409.

In both FIGS. 4A and 4B, UE device 102 is shown as accessing core network 206 through wireless station 106. As previously shown in FIG. 2, wireless station 106 may be situated in access network 204 (not shown in FIGS. 4A and 4B). Although core network 206 may include additional network components, for simplicity they are not illustrated in FIGS. 4A and 4B. For example, core network 206 may include other 4G components, such as a PCRF, an AAA function, etc., and/or 5G components, such as a network Slice Selection Function (NSSF), a Network Repository Function (NRF), a Network Exposure Function (NEF), etc.

FIG. 5 illustrates exemplary fields of records of a table 500 in a database of the DRSS 408 of FIG. 4A or of the AF 418 of FIG. 4B. Table 500 includes information about leased MSISDNs and the devices/accounts to which the MSISDNs are temporarily assigned. Although DRSS 408 may also keep a list of free MSISDNs using registers, variables, a table, etc.—these are not illustrated in FIG. 5. Referring to FIG. 5, table 500 may include multiple records 502, each of which may include an External ID field 504, an MSISDN field 506, a timestamp field 508, an expiration time field 510, and an IMSI field 512. Depending on the implementation, record 502 may include additional, fewer, or different fields than those illustrated in FIG. 5. For example, in a different implementation, record 502 may include a device identifier field that includes, for example, a Media Access Control (MAC) address, an IP address, etc.

External ID field 504 may store an External ID. An External ID typically has two components: a username and a domain (e.g., “Jane.Donut@donutmaker.com”). MSISDN field 506 may include an MSISDN selected from DRSS 408's pool of MSISDNs that may be leased. An MSISDN identifies a specific subscription. An example of MSISDN includes a telephone number, Mobile Directory Number, etc. In an exemplary implementation, an MSISDN may include a country code, a local number, and a subscriber number. When DRSS 408 selects an MSISDN from its MSISDN pool, it removes the selected MSISDN from the pool and records the MSISDN in the MSISDN field 506.

Timestamp field 508 may indicate the time at which the MSISDN in MSISDN field 506 is leased. Expiration time field 510 may indicate the time at which the leased MSIDN may expire or a duration of the time for which MSISDN is leased. IMSI field 512 may include the International Mobile Subscriber Identity.

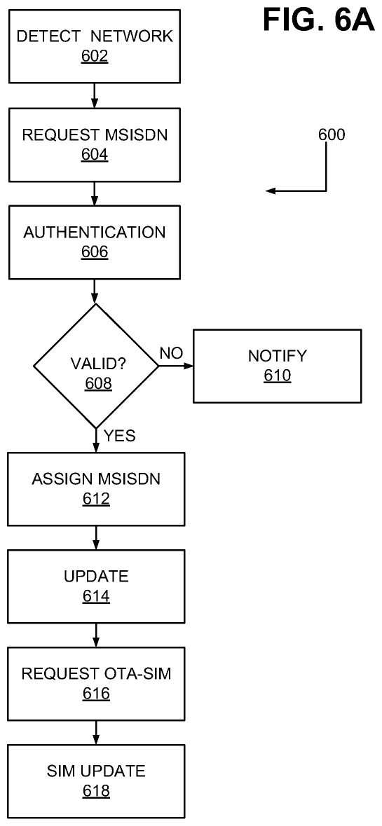

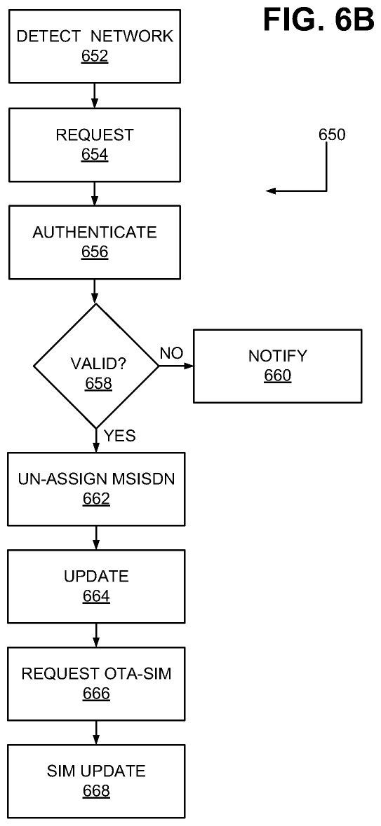

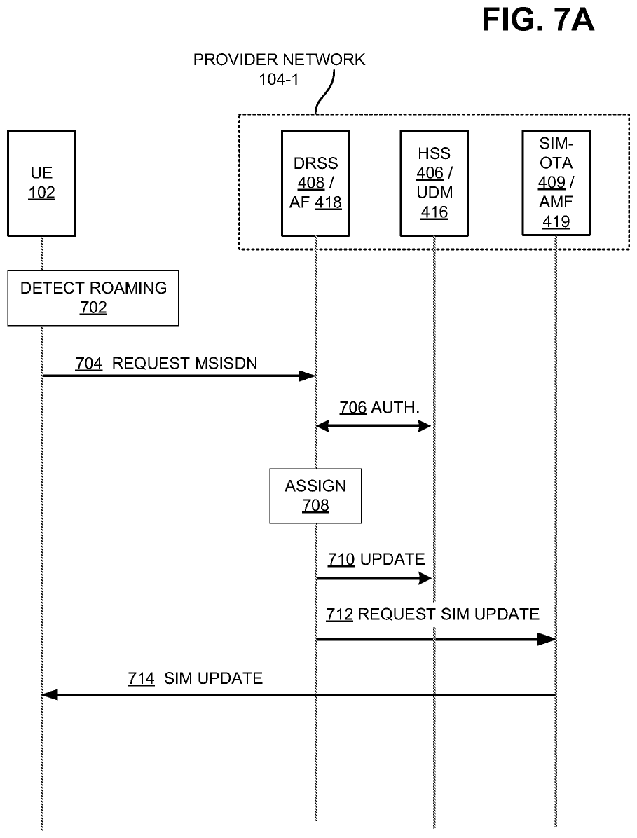

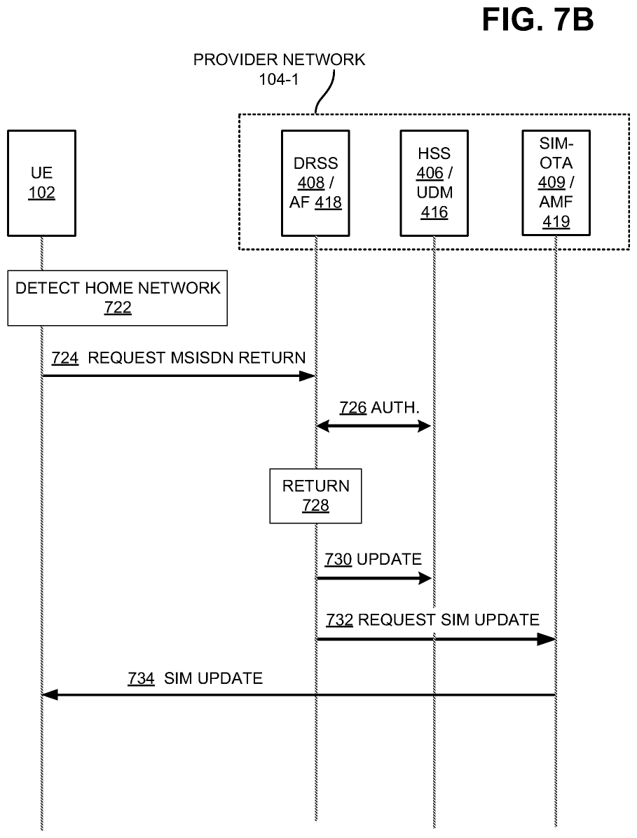

FIG. 6A is a flow diagram of an exemplary process 600 that is associated with allocating an MSISDN for UE device 102. FIG. 7A is a signal flow diagram that is associated with the process 600 of FIG. 6A. Process 600 may be performed by or is associated with the network components and devices of FIGS. 1-5, such as the 4G and 5G core components of FIGS. 4A and 4B, UE device 102, etc. Assume that, prior to the start of process 600, UE device 102 has entered the coverage area of network 104-2.

As shown, process 600 may include UE device 102 detecting a visiting network or its new roaming state (block 602; block 702). When UE device 102 detects network 104-2, UE device 102 may perform its initial attach process, including required authentication at network 104-2. After the completion of the process, UE device 102 may send, via visiting network 104-2, a request for a temporary MSISDN to DRSS 408 in network 104-1 (block 604; signal 704). The request may include the External ID of UE device 102, the IMSI associated with the UE device 102, and a possible expiration time.

When DRSS 408 in network 104-1 receives the request from UE device 102 attached to visiting network 104-2, DRSS 408 may authenticate and/or register UE device 102 at HSS 406 in network 104-1 (block 606: signal 706). If the authentication is not successful (block 608: NO), DRSS 408 may notify the UE device 102 of the authentication failure (block 610).

If HSS 406 is able to validate the identity of UE device 102 (block 608: YES), however, DRSS 408 may select a temporary MSISDN from its pool of MSISDNs that may be leased to UE devices 102 (block 612). DRSS 408 may then assign the selected MSISDN to UE device 102 (block 708). The assignment may entail creating a record 502 in table 500 in the database of DRSS 408. The record 502 may include the selected MSISDN, the External ID of UE device 102, the timestamp associated with the MSISDN selection, and the IMSI of UE device 102. In some implementations, the record may also indicate when the MSISDN is to expire (i.e., expiration time).

Process 600 may further include DRSS 408 requesting HSS 406 to update the user account or profile for the UE device 102, to reflect the MSISDN lease (block 614: signal 710) and requesting SIM-OTA 409 to update the SIM in UE device 102 with the assigned MSISDN (block 616; signal 712). In response to the request, SIM-OTA 409 may then forward the MSISDN to UE device 102 and cause the SIM in UE device 102 to store the MSISDN (block 618; block 714). After the MSISDN has been leased to UE device 102, UE device 102 may roam in network 104-2 and receive their network services.

FIG. 6B is a flow diagram of an exemplary process 650 associated with the UE device 102, to which a temporary MSISDN has been assigned, when the UE device 102 that has been roaming in network 104-2 returns to network 104-1. FIG. 7B illustrates signals that are associated with process 650 of FIG. 6B. Process 650 may be performed by or are associated with the network components and devices of FIGS. 1-5, such as the 4G and 5G core components of FIGS. 4A and 4B, UE device 102, etc. Assume that the SIM in UE device 102 has been updated with a temporary MSISDN, that UE device 102 has been roaming in network 104-2, and that UE device 102 has just returned to the coverage area of network 104-1.

As shown, process 650 may include UE device 102 detecting home network 104-1 (block 652; block 722). When UE device 102 detects network 104-1, UE device 102 may perform its attach process, including authentication at its home network 104-1. After the completion of the process, UE device 102 may send a request to return the MSISDN to DRSS 408 in network 104-1 (block 654; signal 724). The request may include the MSISDN of UE device 102 and the IMSI of UE device 102. In some implementations, the request may also include the possible expiration time and/or the External ID.

When DRSS 408 in network 104-1 receives the request from UE device 102, DRSS 408 may authenticate UE device 102 at HSS 406 in network 104-1 (block 656: signal 726). If the authentication is not successful (block 658: NO), DRSS 408 may notify the UE device 102 of the authentication failure (block 660).

If HSS 406 is able to validate the identity of UE device 102 (block 658: YES), however, DRSS 408 may then un-assign the MSISDN (block 562; block 728). The un-assignment may include removing or marking the record 502, in table 500 in the database of DRSS 408, that was created during the assignment—during process 600. As indicated above, in some implementations, DRSS 408 may not remove the record 502, but indicate that the MSISDN is no longer leased to UE device 102. DRSS 408 may also place the MSISDN in a waiting queue for its eventual return to its pool of MSISDNs that may be leased to UE devices 102.

Process 600 may further include DRSS 408 requesting HSS 406 to update the user account or its profile for the UE device 102, to reflect the release of the ISISDN (or the un-assignment) (block 664: signal 730) and requesting SIM-OTA 409 to update the SIM in UE device 102, such that the SIM no longer includes the MSISDN (block 666; signal 732). In response to the request, SIM-OTA 409 may then update the SIM in UE device 102, to erase/delete the MSISDN in the SIM in UE device 102 (block 668; block 734). After the MSISDN has been released, UE device 102 may no longer be able to receive services from network 104-2 when UE device 102 is in the coverage area of network 104-2.

In this specification, various preferred embodiments have been described with references to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while a series of blocks have been described with regard to the processes illustrated in FIGS. 6A and 6B, the order of the blocks may be modified in other implementations. In addition, non-dependent blocks may represent blocks that can be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store, or employ personal information of individuals, it should be understood that such information shall be collected, stored, and used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

No element, block, or instruction used in the present application should be construed as essential to the implementations described herein unless explicitly described as such. As used herein, the articles “a,” “an,” and “the” are intended to include one or more items. The phrase “based on” is intended to mean “based, at least in part, on” unless explicitly stated otherwise.

1. A network device comprising:
a memory to store processor-executable instructions;
a processor configured to execute the processor-executable instructions to implement a device roaming state server (DRSS) configured to:
receive a request, from a mobile device attached to a first network, to provide the mobile device with a Mobile Station International Subscriber Directory Number (MSISDN), wherein the mobile device has an external identifier (ID) that includes a domain name, wherein the mobile device does not have an MSISDN, wherein the DRSS is in a second network, and wherein the first network is different from the second network;
authenticate the mobile device at the second network;
if the mobile device is successfully authenticated, select a temporary MSISDN from a pool of available MSISDNs;
associate the temporary MSISDN with the external ID in a database; and
provide the temporary MSISDN to the mobile device.

2. The network device of claim 1, wherein when the DRSS associates the temporary MSISDN with the eternal ID, the DRSS is configured to:
create an entry in the database, wherein the entry includes the external ID and the temporary MSISDN.

3. The network device of claim 2, wherein the request includes:
an International Mobile Subscriber Identifier (IMSI).

4. The network device of claim 2, wherein the entry indicates an expiration time for the temporary MSISDN and a time of receipt of the request at the DRSS.

5. The network device of claim 1, wherein when the DRSS authenticates the mobile device, the DRSS authenticates the mobile device at either a Home Subscriber Server or a User Data Management (UDM) function, and wherein the second network includes the HSS or the UDM function.

6. The network device of claim 1, wherein when the DRSS provides the MSISDN, the DRSS is configured to:
instruct a Subscriber Identity Module Over-the-Air (SIM-OTA) to send the temporary MSISDN to a SIM card included in the mobile device and cause the SIM card to store the temporary MSISDN in the SIM card.

7. The network device of claim 1, wherein the DRSS is configured to:
update either a Home Subscriber Server (HSS) or a User Data Management function in the second network with the temporary MSISDN.

8. The network device of claim 1, wherein the first network is not configured to provide network services to a mobiles device that does not include an MSISDN.

9. The network device of claim 1, wherein the mobile device is configured to:
detect the first network when the mobile device enters an area that is serviced by the first network, and
send the request to provide the MSISDN to the DRSS.

10. A method comprising:
receiving a request, from a mobile device attached to a first network, at a Device Roaming State Server (DRSS), to provide the mobile device with a Mobile Station International Subscriber Directory Number (MSISDN), wherein the mobile device has an external identifier (ID) that includes a domain name, wherein the mobile device does not have an MSISDN, wherein the DRSS is in a second network, and wherein the first network is different from the second network;
authenticating the mobile device at the second network;
if the mobile device is successfully authenticated, selecting a temporary MSISDN from a pool of available MSISDNs;
associating the temporary MSISDN with the external ID in a database; and
providing the temporary MSISDN to the mobile device.

11. The method of claim 10, wherein associating the temporary MSISDN with the eternal ID includes:
creating an entry in the database, wherein the entry includes the external ID and the temporary MSISDN.

12. The method of claim 11, wherein the request includes:
an International Mobile Subscriber Identifier (IMSI).

13. The method of claim 11, wherein the entry indicates an expiration time for the temporary MSISDN and a time of receipt of the request at the DRSS.

14. The method of claim 10, wherein authenticating the mobile device includes:
authenticating the mobile device at either a Home Subscriber Server or a User Data Management (UDM) function, and wherein the second network includes the HSS or the UDM function.

15. The method of claim 10, wherein providing the MSISDN includes:
instructing a Subscriber Identity Module Over-the-Air (SIM-OTA) to send the temporary MSISDN to a SIM card included in the mobile device and cause the SIM card to store the temporary MSISDN in the SIM card.

16. The method claim 10, further comprising:
updating either a Home Subscriber Server (HSS) or a User Data Management function in the second network with the temporary MSISDN.

17. The method of claim 10, wherein the first network is not configured to provide network services to a mobiles device that does not include an MSISDN.

18. The method of claim 10, wherein the mobile device is configured to:
detect the first network when the mobile device enters an area that is serviced by the first network, and
send the request to provide the MSISDN to the DRSS.

19. A non-transitory computer-readable medium, comprising computer-executable instructions, that when executed by one or more processors, cause the one or more processors to implement a Device Roaming State Server (DRSS), wherein the DRSS is configured to:
receive a request, from a mobile device attached to a first network, to provide the mobile device with a Mobile Station International Subscriber Directory Number (MSISDN), wherein the mobile device has an external identifier (ID) that includes a domain name, wherein the mobile device does not have an MSISDN, wherein the DRSS is in a second network, and wherein the first network is different from the second network;
authenticate the mobile device at the second network;
if the mobile device is successfully authenticated, select a temporary MSISDN from a pool of available MSISDNs;
associate the temporary MSISDN with the external ID in a database; and
provide the temporary MSISDN to the mobile device.

20. The computer-readable medium of claim 19, wherein when the DRSS associates the temporary MSISDN with the eternal ID, the DRSS is configured to:
create an entry in the database, wherein the entry includes the external ID and the temporary MSISDN.
